(19) United States
(12) Patent Application Publication
(10) Pub. No.: US 2015/0193598 A1
(43) Pub. Date: Jul. 9, 2015

(54) METHOD AND APPARATUS FOR DRIVER NOTIFICATION HANDLING

(71) Applicant: Ford Global Technologies, LLC, Dearborn, MI (US)

(72) Inventors: Joey Ray Grover, Madison Heights, MI (US); Joel Fischer, Royal Oak, MI (US); Justin Dickow, Royal Oak, MI (US)

(73) Assignee: Ford Global Technologies, LLC, Dearborn, MI (US)

(21) Appl. No.: 14/148,129

(22) Filed: Jan. 6, 2014

(51) Int. Cl. G06F 21/10; H04L 29/08

(52) U.S. Cl. CPC G06F 21/10; H04L 67/025

(57) ABSTRACT

A system includes a processor configured to receive a notification request from an entity in communication with a vehicle computing system (VCS). The processor is also configured to receive notification content and parameters. The processor is further configured to validate a right of the entity to display a notification on the VCS. Also, the processor is configured to validate the content based on permitted content. The processor is additionally configured to validate the parameters based on permitted parameters and queue a notification for display following successful right, the content and parameter verification.

### TECHNICAL FIELD

The illustrative embodiments generally relate to a method and apparatus for driver notification handling.

### BACKGROUND

In a vehicle that includes a vehicular computing system, a vehicle head unit may shown notification to the driver from embedded applications or technologies. One example of this could be when a driver receives a phone call from a connected phone. The vehicle computer may be notified of the call, any on-screen activity may be interrupted, and a notification may be displayed on the head unit.

Notifications which include confirmation and/or cancellation messages may be distracting to a driver, especially in high driver-distraction-type situations (e.g., without limitation, high traffic, weather, turning, lane changing, etc.). Further, with a multitude of connected devices, many devices and/or applications may be attempting to send messages to a vehicle system, and so some system for ordering the messages by priority may be needed.

### SUMMARY

In a first illustrative embodiment, a system includes a processor configured to receive a notification request from an entity in communication with a vehicle computing system (VCS). The processor is also configured to receive notification content and parameters. The processor is further configured to validate a right of the entity to display a notification on the VCS. Also, the processor is configured to validate the content based on permitted content. The processor is additionally configured to validate the parameters based on permitted parameters and queue a notification for display following successful right, the content and parameter verification.

In a second illustrative embodiment, a computer-implemented method includes receiving a notification request from an entity in communication with a vehicle computing system (VCS). The method also includes receiving notification content and parameters. Further, the method includes validating a right of the entity to display a notification on the VCS. The method additionally includes validating the content based on permitted content. Also, the method includes validating the parameters based on permitted parameters and queuing a notification for display following successful right, the content and parameter verification.

In a third illustrative embodiment, a non-transitory computer-readable storage medium stores instructions that, when executed by a processor, cause the processor to perform a method that includes receiving a notification request from an entity in communication with a vehicle computing system (VCS). The method also includes receiving notification content and parameters. Further, the method includes validating a right of the entity to display a notification on the VCS. The method additionally includes validating the content based on permitted content. Also, the method includes validating the parameters based on permitted parameters and queuing a notification for display following successful right, the content and parameter verification.

### BRIEF DESCRIPTION OF THE DRAWINGS

FIG. 1 shows an illustrative vehicle computing system;

FIG. 2 shows an exemplary block topology of a system for integrating one or more connected devices with the vehicle based computing system according to an embodiment;

FIG. 3 shows an illustrative example of a global notification system request receipt;

FIG. 4 shows an illustrative example of a global notification system request generation; and

FIG. 5 shows an illustrative example of a prioritization scheduling process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

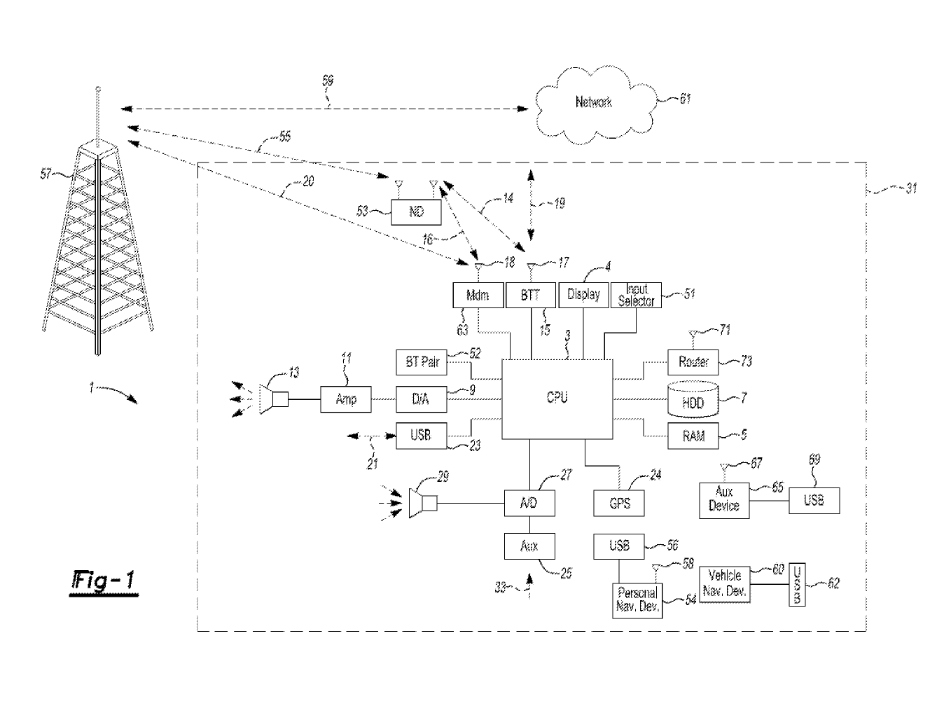

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

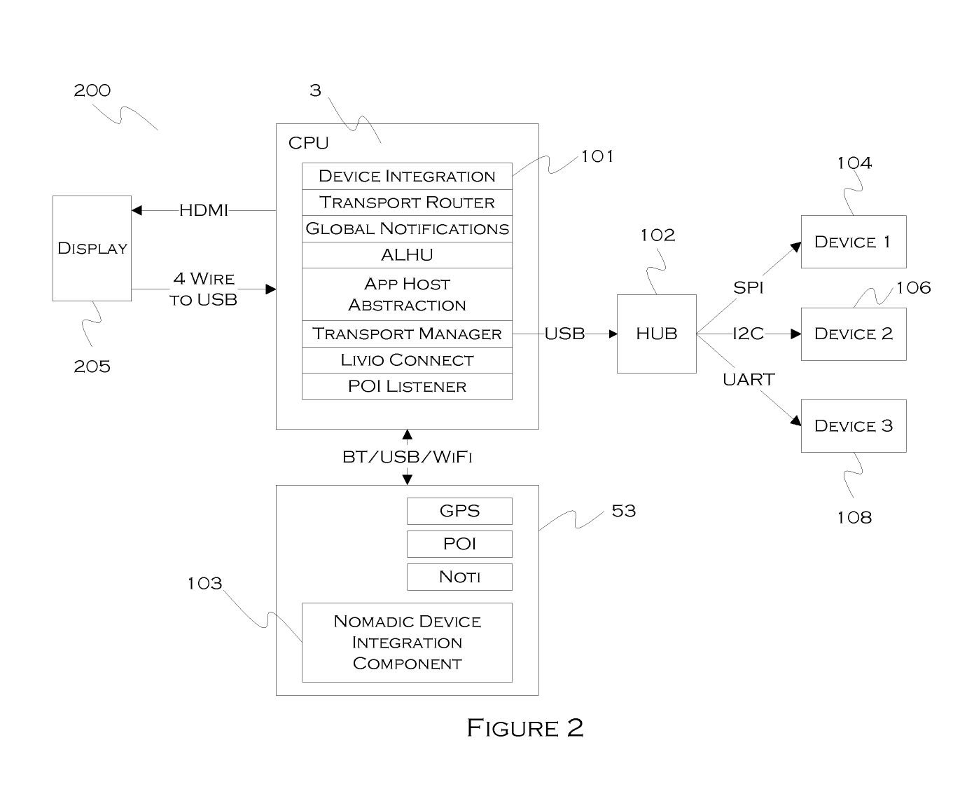

FIG. 2 is an exemplary block topology of a system 200 for integrating one or more connected devices with the vehicle based computing system 1 (VCS). The CPU 3 may be in communication with one or more transceivers. The one or more transceivers are capable for wired and wireless communication for the integration of one or more devices. To facilitate the integration, the CPU 3 may include a device integration framework 101 configured to provide various services to the connected devices. These services may include transport routing of messages between the connected devices and the CPU 3, global notification services to allow connected devices to provide alerts to the user, application launch and management facilities to allow for unified access to applications executed by the CPU 3 and those executed by the connected devices, and point of interest location and management services for various possible vehicle 31 destinations.

As mentioned above, the CPU 3 of the VCS 1 may be configured to interface with one or more nomadic devices 53 of various types. The nomadic device 53 may further include a device integration client component 103 to allow the nomadic device 53 to take advantage of the services provided by the device integration framework 101.

The one or more transceivers may include a multiport connector hub 102. The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108.

Whenever a process, application or device requests the use of a vehicle computer's resources, there is the potential for overlap with another request and/or driver distraction. For example, if a phone and radar detector both wish to send a message to a driver at the same time, one will need to be given priority so that the messages can be displayed successively. Further, it may be desirable to prevent certain messages, media and driver interaction requests during times of high driver distraction, or simply in general.

Accordingly, the illustrative embodiments provide for notification handling and processing. Among other things, the embodiments present solutions for ordering notification requests, prioritization of requests, presentation/blocking of requests and other request handling. When a connected device or application sends a request, the handling process will determine if/when the requested message can be displayed. Further, the process will determine which messages have priority over other messages, to prevent simultaneous attempted use of resources, and to optimize presentation of notifications to the driver.

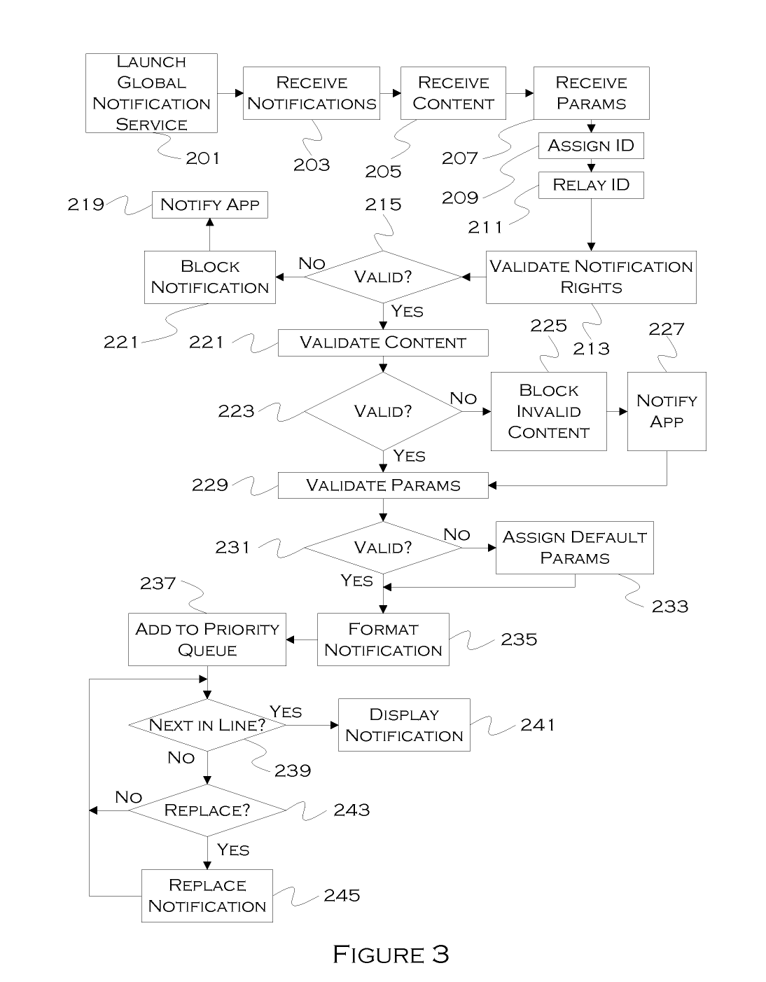

FIG. 3 shows an illustrative example of a global notification system request receipt. The global notification system is a process for request handling. In this illustrative embodiment, it at least handles requests for use of the vehicle display.

In this illustrative example, a global notification service is launched 201. This service will handle the incoming requests, and in this example, the process of request handling is shown from the perspective of the global notification service (or the processor interacting with/running the service). In this example, the process first receives a request for utilization of a driver display (e.g., to present a notification) 203.

In addition to receiving the request, the process receives content to be displayed to the driver 205. In some instances, the process will simply receive text to be presented to the driver. In these simple situations, the global notification service may serve to verify the permissibility of the text and to format the text to a uniform standard font (if appropriate/desired). In other instances, the request may include responsive controls (confirm/reject/etc.), multi-media, artwork, etc. In addition to verifying the permissibility of these requests, the global notification service may reject certain content deemed inappropriate for driver display (for example, because it may be too distracting).

The process may also receive some number of parameters associated with a given request 207. The parameters may include, for example, a requested priority status (urgency), conditional display modifiers (triggers), primary/secondary text, possible driver actions, message category, etc. Other suitable parameters may be included as appropriate.

Once the request is received by the process, a message ID may be assigned 209. This message ID, which can be sent back to the requesting entity 211, can be used for identifying the message, for message status requests from the entity, and for any other suitable purpose. By associating an ID with the message, it may be easy for the requesting entity to check on a status of the requested message.

In this illustrative example, the global notification service first attempts to validate the rights of the requesting entity to utilize a notification service at all 213. Invasive programs, and even benign programs, may attempt to use notification services without permission. Since it is possible to distract a driver through notifications, automotive manufacturers may be protective of notification requests, and only allow certain pre-approved applications or function calls, or circumstantial requests, to utilize the notification service. Accordingly, the global notification service may first verify that the requesting entity has the rights to provide notification of any sort.

If the notification utilization is invalid 215, the process may block the notification 217 and notify the application (if desired) that notification has been blocked 219. On the other hand, if general notification utilization is permitted, the service may proceed to validate the content of the notification 221.

Since some applications and processes may attempt to send notifications containing media requests, or requests that require driver responses, the process may not allow these notifications depending on driver distraction levels, application permission rights, and general degree of distraction associated with the requested notification. A driver, or an automotive manufacturer, may generally prohibit any notification including video over three seconds, for example. Or any notification including video at all. Any suitable protection parameters may be set for content, and the content distribution may be conditional too (i.e., permitted at some times, prevented at others).

If the content is invalid 223, the process may block the invalid content (such as preventing video, but permitting text) 225. The application requesting the notification may be notified that some/all content was blocked 227, in order to give the requesting entity a chance to re-submit a more permissible form of notification.

Finally, in this example, the process may validate the requested parameters associated with the request 229. For example, if the application includes a high-urgency parameter, the process may verify either that the requesting application is permitted to submit high-urgency request or, for example, that a high-urgency request is permitted at this time (e.g., a higher prioritized application may already be utilizing the right to submit high urgency notifications, such as a weather or emergency application). Other parameters of the application may also be verified, such as, but not limited too, number of times displayed, secondary actions, conditions for display, etc.

If any parameter is invalid 231, the process may assign a default parameter in place of the invalid parameter 233. For example, if it is requested that the notification be displayed thrice, but only a single display is permitted, the process may substitute a single display for the requested triple display. Other suitable default parameters may also be assigned, either in generalized form or that are specific to the requested but denied parameter. For example, the process may substitute a “general priority” in place of a denied high-priority request, or, in another case, the process may substitute an “increased priority” which gives higher than general but lower than high priority, depending on settings provided to the global notification service.

Once all content and parameters have been validated and/or corrected, the process may format the notification such that a standard format of notification may be used 235. Text, graphics and any requested responses are, in this case, set to a standardized format. This can help to minimize driver distraction, since the driver is less likely to search for a response button or be too distracted by a new form of advertisement or notification.

The notification can then be added to a priority queue, if any such queue exists 237. Prioritization can be based on permitted parameters associated with the request, or, for example, based on currently pending notifications. Certain types of requests may be given certain priority as well, for example, navigation notifications may be given priority over more generalized notifications, and weather notifications may be given even more heightened priority.

Once a certain notification is next-in-line 239, the process will display the notification as permitted by the global notification service 241. While the notification is pending, the process can check to see if any of the previously rejected elements of the notification have been resubmitted for replacement 243. For example, if a video was rejected, the application may send a static image in place of the video. Following suitable verification, if desired, the global notification service may replace the pending notification with the re-submitted updated notification 245.

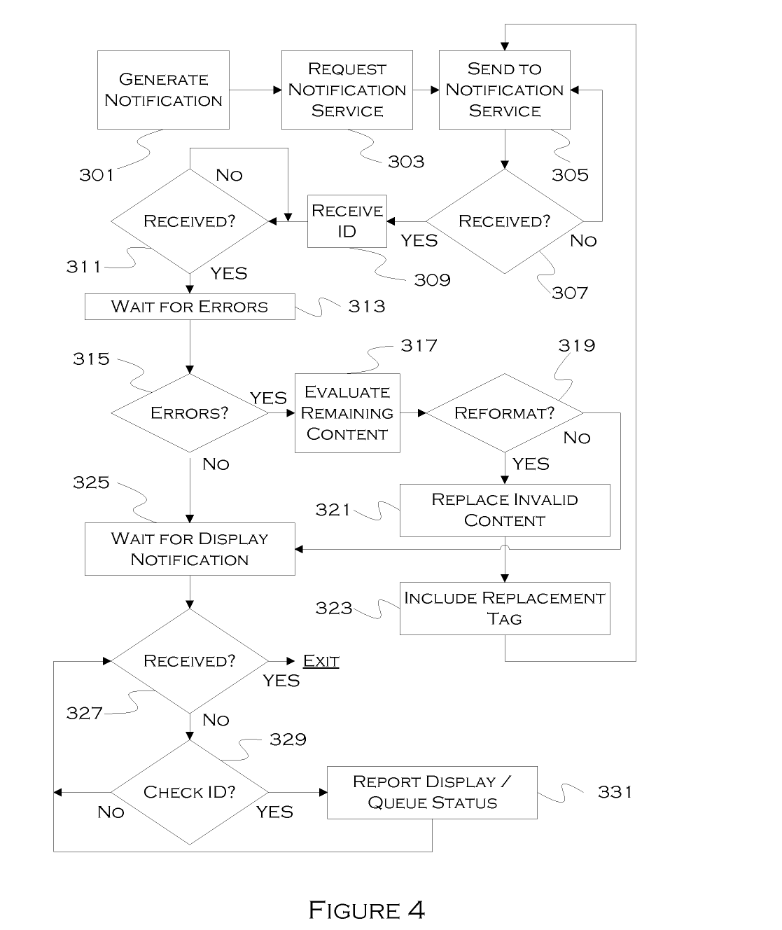

FIG. 4 shows an illustrative example of a global notification system request generation. This process shows an exemplary form of a notification request from the perspective of a requesting entity. In this illustrative example, the entity first generates a notification. This could be, for example, without limitation, a weather report, a radar report, navigation directions, a new song title, etc., based on the sort of notifications that a particular application generates.

Once the notification has been locally formatted and assembled, the process may request use of a global notification service (discussed with respect to FIG. 3). The formatted notification is then sent to the notification service 305, and the requesting/sending can continue until the service verifies receipt of the request 307.

In response to the received request, the global notification service may send a notification ID back to the requesting entity 309. The local entity can use this ID to modify and/or track the pending notification. The ID can also be included with any response data, so that the requesting entity can associate the response data with the appropriate notification. Once the ID has been received 311, the process can wait for “errors” or other rejection messages 313. If any errors or rejection messages are discovered 315, the process can take appropriate action.

For example, a rejection message rejecting content or parameters of the requested notification may be received. The rejected content or parameters may be evaluated 317 and the message or parameters may be reformatted if needed 319. If there are any replacements to be sent, the process may replace the invalid content/parameters 321. A replacement tag may be included with the reformatted notification request 323, so that the global notification service knows that the process is requesting a currently existing notification to be reformatted.

If there are no errors, or if reformatting is not desired, the process may wait for a response that the notification has been displayed to the driver 325. Once the notification has been received 327, the process can exit (assuming no secondary actions are required, such as a follow up notification or a driver response). If the notification has not yet been displayed, the process can use the ID to check the display status (e.g., queue location) 329. If an ID request is submitted, the process may receive a current queue status 331 for use by the application if needed.

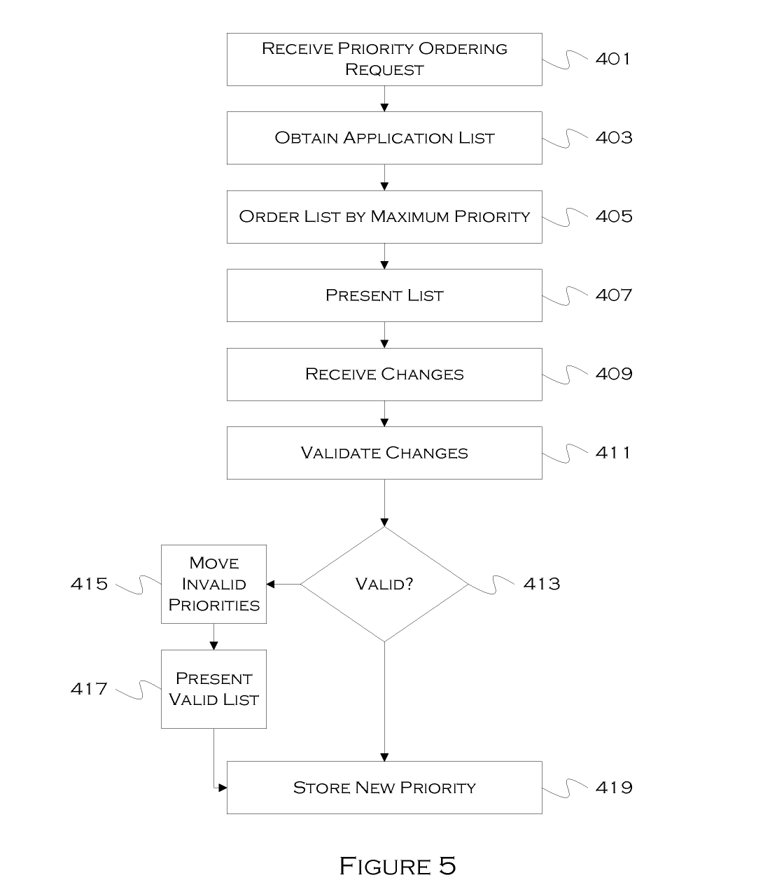

FIG. 5 shows an illustrative example of a prioritization scheduling process. In this illustrative example, the driver can specify the priority of certain types of notifications. For example, if a driver has a weather application, a music application and a radar detector interfacing with the vehicle computer, the driver may want to personalize the priority of notifications from these applications.

For example, the driver may want radar to have the highest priority (since quick reactions are often needed), followed by severe weather alerts, followed by new song titles, followed by general weather updates. These may have been previously sorted based on, for example, a first in first out (FIFO) basis. But a driver may wish to customize this ordering.

Accordingly, the process may receive a request for priority ordering from the driver 401. In response to this request, a list of existing applications may be retrieved 403. This could be a list of all applications, or a list of only applications that have ever submitted a notification request (which can be tracked). In another instance, the list may be based on types of applications as opposed to specific application names (e.g., traffic, weather, entertainment, etc.) Any suitable means of presenting a plurality of options to be prioritized may be used.

The retrieved list, in whatever format is desired, may be ordered by a current maximum priority. So, for example, in the above example, “environment” applications, such as weather and radar may be given priority over “entertainment applications” such as the music application. The ordered list may then be presented to the driver 407.

The driver can then interact with the list to re-order a selection, which, in the example above, would constitute moving new-song notifications above general weather reports, and prioritizing radar over severe weather reports (assuming they are current given equal footing under the general “environment” classification). Once all appropriate changes have been received 409, the process may need to validate the changes 411.

For example, if a driver attempts to move emergency alerts to a low-priority status, this may not be permitted by the system controller (e.g., an automotive manufacturer). Other orderings may also be prohibited as is suitable. If the reordering is valid 413, the process may store the new priority queue 419. On the other hand, if the reordering is not valid, the process may move the invalid priorities back to an appropriate location 415. For example, a priority moved to low may be moved back to the lowest permissible slot (although not necessarily back to its original slot). A new list may then also be presented to the driver 417, showing the “corrections” based on the re-ordering. This list may then be stored (pending driver confirmation if required).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a notification request from an entity in communication with a vehicle computing system (VCS);
receive notification content and parameters;
validate a right of the entity to display a notification on the VCS;
validate the content based on permitted content;
validate the parameters based on permitted parameters; and
queue a notification for display following successful right, the content and parameter verification.

2. The system of claim 1, wherein the entity includes a radar detector.

3. The system of claim 1, wherein the entity includes an application running on a remote device.

4. The system of claim 1, wherein the permitted content includes certain types of content.

5. The system of claim 1, wherein the permitted content includes certain types of content in predefined situations.

6. The system of claim 1, wherein the processor is further configured to receive replacement content to replace content that is invalidated.

7. The system of claim 6, wherein the processor is further configured to replace a queued notification with a new notification generated based on received replacement content.

8. The system of claim 1, wherein the processor is further configured to generate a notification according to a predefined format based on the received notification request and content.

9. The system of claim 1, wherein the processor is further configured to report invalidated content to the entity.

10. The system of claim 1, wherein the processor is further configured to replace invalidated parameters with predefined generic parameters.

11. A computer-implemented method comprising:
receiving a notification request from an entity in communication with a vehicle computing system (VCS);
receiving notification content and parameters;
validating a right of the entity to display a notification on the VCS;
validating the content based on permitted content;
validating the parameters based on permitted parameters; and
queuing a notification for display following successful right, the content and parameter verification.

12. The method of claim 11, wherein the entity includes a radar detector.

13. The method of claim 11, wherein the entity includes an application running on a remote device.

14. The method of claim 11, wherein the permitted content includes certain types of content.

15. The method of claim 11, wherein the permitted content includes certain types of content in predefined situations.

16. The method of claim 11, wherein the method includes receiving replacement content to replace content that is invalidated.

17. The method of claim 16, wherein the method includes replacing a queued notification with a new notification generated based on received replacement content.

18. The method of claim 11, wherein the processor is further configured to report invalidated content to the entity.

19. The method of claim 11, wherein the processor is further configured to replace invalidated parameters with predefined generic parameters.

20. A non-transitory computer-readable storage medium, storing instructions that, when executed by a processor, cause the processor to perform a method comprising:
receiving a notification request from an entity in communication with a vehicle computing system (VCS);
receiving notification content and parameters;
validating a right of the entity to display a notification on the VCS;
validating the content based on permitted content;
validating the parameters based on permitted parameters; and
queuing a notification for display following successful right, the content and parameter verification.
